(19) United States
(12) Patent Application Publication
(10) Pub. No.: US 2020/0286403 A1
(43) Pub. Date: Sep. 10, 2020

(54) SYSTEM AND PLATFORM FOR PROVIDING INVESTMENT RELATED TRAINING

(71) Applicant: Ibble, Inc., Austin, TX (US)

(72) Inventors: Raymond J. Kaminski, Austin, TX (US); Eric J. Albee, Austin, TX (US); Irving W. Lee, Austin, TX (US)

(21) Appl. No.: 16/811,466

(22) Filed: Mar. 6, 2020

Related U.S. Application Data
(60) Provisional application No. 62/814,345, filed on Mar. 6, 2019.

(51) Int. Cl. G09B 19/18; G06Q 40/04; G09B 9/00; G09B 7/02

(52) U.S. Cl. CPC G09B 19/18; G09B 7/02; G09B 9/00; G06Q 40/04

(57) ABSTRACT

A platform configured to education users associated with trading in assets such as stock, bonds, and cryptocurrency. In some cases, the platform may be configured to identify individuals that are skilled with respect to trading one or more type of asset based on a user's performance in various types of content hosted by the platform.

### CROSS-REFERENCE TO RELATED APPLICATION(S)

This application claims priority to U.S. Provisional Application No. 62/814,345 filed on Mar. 6, 2019 and entitled “System and Platform for Providing Investment Related Training,” which is incorporated herein by reference in its entirety.

### BACKGROUND

Today, many first-time investors are often overwhelmed with the complexity of conventional investing platforms and trading methodologies. These first-time investors often become overwhelmed and, thereby, fail to take advantage of the opportunities provided by various marketplaces and exchanges. Many of the conventional investment platforms only enhance a first-time investors anxiety by focusing on deals that encourage premature and uneducated entry in to the market.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example architecture associated with a trading platform configured to provide educational content according to some implementations.

FIG. 2 illustrates an example pictorial view of a user's performance during a trading game associated with the platform of FIG. 1 according to some implementations.

FIG. 3 illustrates another example pictorial view of a user's performance during a trading game associated with the platform of FIG. 1 according to some implementations.

FIG. 4 illustrates an example pictorial view of a user's transaction history associated with the platform of FIG. 1 according to some implementations.

FIG. 5 illustrates an example series of pictorial views associated with the show of the platform of FIG. 1 according to some implementations.

FIG. 6 illustrates an example pictorial view of a user's portfolio associated with the platform of FIG. 1 according to some implementations.

FIG. 7 illustrates an example series of pictorial views associated with trading based on strategies associated with the platform of FIG. 1 according to some implementations.

FIG. 8 illustrates an example series of pictorial views associated with creating strategies associated with the platform of FIG. 1 according to some implementations.

FIG. 9 illustrates an example series of pictorial views associated with a knowledge game associated with the platform of FIG. 1 according to some implementations.

FIG. 10 illustrates an example flow diagram showing an illustrative process for identifying influencers according to some implementations.

FIG. 11 illustrates an example flow diagram showing an illustrative process providing educational content to a user according to some implementations.

FIG. 12 illustrates an example flow diagram showing an illustrative process associated with the trading game content according to some implementations.

FIG. 13 illustrates an example platform associated with providing education-based asset trading according to some implementations.

### DETAILED DESCRIPTION

Described herein is a platform configured to assist in user education with regards to investment and stock trading. For example, many first-time investors are often overwhelmed with the complexity of conventional investing platforms and trading methodologies. These first-time investors often become overwhelmed and, thereby, fail to take advantage of the opportunities provided by various marketplaces and exchanges. Many of the conventional investment platforms only enhance a first-time investors anxiety by focusing on deals that encourage premature and uneducated entry into the market. For example, conventional platforms often focus on the “get started now” “invest now” “don't miss out” type marketing and deals which benefits the platform by encouraging individuals to incur breakage fees but ultimately may harm the individuals. However, the platform, discussed herein, unlike the conventional investing platforms is designed to create a system that unlocks knowledge, facilitates real world conversation and connections, builds users confidence over time, and provides an educational experience over a deal experience.

In some cases, the platform works first works to educate the user regardless of the amount of time required to prepare the user to invest. In this manner, the user may be fully prepared when the user first invests with actual fiat money. Thus, the current platform is individual focused and configured to encourage the user to learn through test or trial experiences and to only invest when ready.

In one example, the platform may be configured to filter news or articles for the user to assist the user in consuming relevant educational materials that increase the user's investment and stock trading knowledge. Without the aid of the platform, discussed herein, there is far too much information for an unsophisticated or new investor to filter, consume, and comprehend. In fact, many published articles are in fact click bait type promotions intended to trick or cause the user to invest in a desired product and do not provide any educational information at all.

To assist with filtering the articles and content for the end user, the platform, discussed herein, may select a set of companies per day (e.g., 3, 4, 5, 6, 10, etc. companies) to focus the educational aspect and the content to, for example, a single industry, topic, or educational theme. By restricting the number of companies and selecting the companies on behalf of the users, the platform is able to curate news around certain events such as earning reports, new product releases, acquisitions, updates, etc. that are focused on the selected companies. In this manner, the articles may be focused to provide educational training to the users in different areas each day. In some cases, the companies may be related by industry, products, size, market share, market trends, etc.

In one example, the platform may parse or scrapes articles from credible new media sites (such as third-party news providers, financial institutes, or other respected publications). The platform may validate and rate the articles and then provide a shortened summary of the content via the platform, such that the user of the system may quickly extract the important information and improve the user's knowledge without requiring the user to spend extended time on each article.

In one example, the articles may be selected based at least in part on a comparison of the content of multiple articles for similar words or phrases. A set of articles that each includes overlapping content may then be selected for publication. In some cases, the platform may identify articles that have similar names, key words, and related market performance data. In some cases, the platform may include a content team or system that may analyze the selected articles to generate the summaries.

In this way, the platform allows the user to slowly increase knowledge, gathering portions of information and providing an easy way for users to have real world conversations, as the platform provides enough information in the summaries to facilitate starter conversations.

In some implementations, the platform may also include a show that starts at a specified period of time each period (e.g., day). The show may include a live stream of a topic matter expert providing commentary on the selected companies. In some cases, the content of the show may be related to content of the selected and summarized articles. In some example, the users have the ability to chat via the platform while the show is being broadcast. In some case, the show may be a fixed period of time, such as 3-4 minutes. During each show, the platform may ask the users or viewers a series of market sentiment related questions. For example, if we are focused on Company C for the day we may ask “Do you like the CEO?”, if we focused on Company B for the day we may ask “Will you buy the new phones offered by Company B?” The questions may take the form of a binary yes or no answers and there is no right or wrong answer. In one implementation, the system will ask a set number of questions (such as two or more) during the show. The users may not be required to answer the questions, but by answering the questions the users become eligible to participate in a knowledge game (such as, in some cases, a daily game).

In this example, users are able to comment on live shows, as well as see other user's comments. Comments that are posted during a show that is currently occurring are sent to the server and database for ingestion and are aggregated based on time of arrival. Comments are returned to user-agents to be displayed to the users. For streams that occurred in the past, users will receive historical comments from users who watched the show prior to them, delivered from the server. Users are able to comment on videos that occurred in the past by submitting comments to the server and database. The server will add the comment to the other collection of comments and place within a subset of the comments based on the elapsed time of the past stream at which the user-agent sent the comment to the server.

In some cases, comments are checked against a list of words that may be considered offensive, inappropriate, or lewd and removed accordingly. Users are assessed based on the amount and frequency of submitted offensive material and may face disciplinary action against their accounts within the platform.

When a show is streamed or viewed by a user, a request is sent to the server indicating that the user has viewed a video. This action is recorded in the database and can be used for purposes such as to track the user's engagement, qualify the user to participate in games/challenges, award the user for use of the platform as will be discussed in further detail below.

Show-related user data, such as, but not limited to, the number of viewers of the video, the types of responses users make to questions presented to the user before, during, or after a show, can be sent to the database and server and proceed to be aggregated, anonymized and redistributed to the users and the system, with the potential to alter the current dialog/content of the current show.

Before, during, and after a show, a show operator associated with the platform may send data to the database that contains feedback-items designed to be presented to the user. These feedback items include, but are not limited to, market-sentiment questions, challenge questions regarding financial markets, individual ticker symbols, and recent news. In some cases, the data may be used to build user profiles (such as using the stock choices to gauge a user's market savviness and provide them with curated recommendations) monetized sentiment questions based on strategic marketing/advertising partnerships, among others. This data will be propagated to all active viewers of the show through the user's agent and both responses and non-responses will be sent back to the server and possibly analyzed in real-time, presented back to the users and the platform, with the potential of altering the current dialog/content associated with the corresponding show.

In some implementations, following the completion of the live show, if the user is qualified to play the knowledge game (the user is signed up and has answered at least two market sentiment questions) the game will commence. During the game, the platform may first ask questions related to the selected companies. The questions may be predicative in nature, such as “do they believe those publicly traded stocks will go UP or DOWN in the next trading day.” Next, the platform asks the user to select a biggest winner or loser (percentage-based stock growth) the next day (e.g., the day after the game is played). For example, the user may rate the selected companies based on the expected or predicted performance. The platform may then determine a winner based on the performance of the stock market on the following period or day.

In some implementations, the knowledge game is equally weighted, everyone has the same chance to win and there may be three types of questions asked, a type focused on whether or not the selected companies' stock will go up or down, a type associated with who will be the biggest winner on the following day of trading from a percentage standpoint, and a third type in which from the user may select the company that is the largest loser on the next day of trading from a percentage standpoint.

In some cases, based on the number of users watching or participating in the game, the platform may tune the level of difficulty for each game. For example, the platform may choose to suppress the 2nd and 3rd question, and only the 1st question may appear. This allows the platform to normalize the number of winners per show/game (e.g., more questions for more users).

In addition to the knowledge game, the platform may provide a trading game or longer game (e.g., a game having a larger period of time to complete). The trading game may include providing the users that qualify with a seed (fictional) monetary value. In some implementations, different users may be seeded with different monetary value (e.g., each user does not necessarily start out with the same amount of seed money). For example, the winners of the knowledge game may receive a competitive advantage in terms of seed money when participating in the trading game. In other cases, users that consumed the summaries or the show may also receive additional seed money when the trading game begins. Both of these methods are adding more content (including educational content) to the platform, and the users are awarded as such.

During the trading game, the users may be able to invest the fictional seed money and compete to see who can earn the highest return during the corresponding period of time. Thus, the winner is determined by the user with the most amount of fictional currency in their virtual trading account at the end of each week.

During the trading game, each user may have the ability to create custom strategies that are comprised of stocks, bonds, cryptocurrency, and commodities. The user can have multiple strategies. If a user creates a portfolio focused on green energy, automotive, or social media tech the user may toggle on and off strategies like topics instead of buying or selling the underlying investments, thus allowing the game to consume less of a user's time.

At the end of each period, the winners of the game may be displayed in a leaderboard. However, during the knowledge and trading games, the platform is able to evaluate users and strategies based on a week over week performance. Thus, the platform is able to identify individual that show a high level of talent or skill with respect to stock trading as well as strategies that emerge as effective in various situations.

If the user has performed above a threshold level (e.g., in the top percentage or earning greater than a threshold amount) throughout a predetermined period of time, the user may be invited by the platform to join as a market influencer. As an influencer, the user may demonstrate their market performance and share strategies. In some cases, either influencers or top performing users may be matched to third-party investors who want a broker having a strategy or results similar to the performance of the influencer captured during the games. In this manner, the platform is able to identify users that perform well and make either the users or the strategies available to investors to select as a more custom or guided investment strategy without requiring hiring a personal broker. In this manner, the platform is able to provide guided investment or custom strategy investing to a larger portion of the population than conventional trading platforms. Additionally, the investors may view the performance of the users based on the outcome or winnings in the game environment, thus, allowing investors to feel more at ease or to be more easily able to evaluate the skill of the “broker”.

In some cases, the platform selects each influencer or top performing user by analyzing a combination of quantitative data points that objectively identify successful traders based on exceeding defined thresholds. For example, the platform may determine who makes the most money consistently during each trading week. Alternatively, the platform may determine key statistics on each user, and evaluate each user objectively using various techniques, such as Performance vs. Benchmark (S&P) percentage rate of return compared against the S&P 500 index, comparing percentage return on portfolio against percentage return of SPY and/or S&P 500 for a designated time period, determine a percentage rate of return on total deposited funds to a percentage rate of return on total capital deposited, comparing a current balance to a total deposited balance divided by a total deposited, weekly profits, change in balance for a period of time, change in profits over a period of time, a win rate, number of profitable trades v. number of trades, amount earned in a single day, a maximum intraday drawdown percentage compared to a maximum portfolio loss from peak to trough, a intraday trough value minus an intraday peak value divided by a peak value, maximum lifetime drawdown percentage v. the amount of money lost from a recent portfolio high before making a new trade, an all-time portfolio trough value minus all time peak value divided by an all time peak value, users with the highest number of wins, longest win streak, highest average profits from each profitable closing, overall profit divided by the number of profitable trades, highest number of losses, longest losing streak, average loss per day, overall loss divided by number of losing trades, average value of each trade, trading volume, number of shared trades, amount of earnings after commissions, gross profit divided by commissions, expectancy value, percentage of wins times the average win amount minus percentage of losses times the average loss amount, total of all winning trades divided by a value of losing trades, gross profits divided gross losses, reward v. risk ratio, average

In some cases, the platform may also allow for trading in fiat currency-based trading. The platform may also allow the users to utilize the same strategies or portfolios the user created and tested using the games. In some examples, users may be able to follow high performing strategies from a market influencer or top performer. In this case the follower may pay a small subscription fee to the influencer or top performer.

In some implementations, machine learning or artificial intelligence may be used. For example, in the knowledge game the platform may use machine learning to determine a model or network to receive future data that assists in determining companies to select, data associated with the users, top performers, select influencers, build strategies, etc.

In some cases, the platform may allow users the ability to set up a group and play together (no prizes unless sponsored by the organization). The platform may predict local universities providing this to their economic and/or finance departments to simulate trading and perform analysis on stocks throughout the day.

In some cases, games may be linked based on time. For example, the knowledge games are unlocking knowledge and potentially exposing the user to companies they did not previously know much about. The ability to interact with the knowledge game gives the user a starting bonus to the trading game each week, which nurtures the highly engaged user with a competitive advantage and additional knowledge. The platform may also execute the trading game during open market weekdays to ensure the user does not get bored and the user may easily test out new theories. The user can adjust their trading game portfolio throughout the week.

As discussed above, in some cases, influencers that are consistently performing well can be matched with third-party traders based on the third-party traders' news interaction data, knowledge game data, and their portfolio data. If the user does not perform well the platform may replace the influencer for the third-party traders.

In one particular example, by gauging sentiment questions and how the user speculates about the company's performance, the platform may determine that the user would be highly relevant to a company for data surveying or for hire and recommend that the user apply for a position or recommend to the company that the company's representatives reach out to the user.

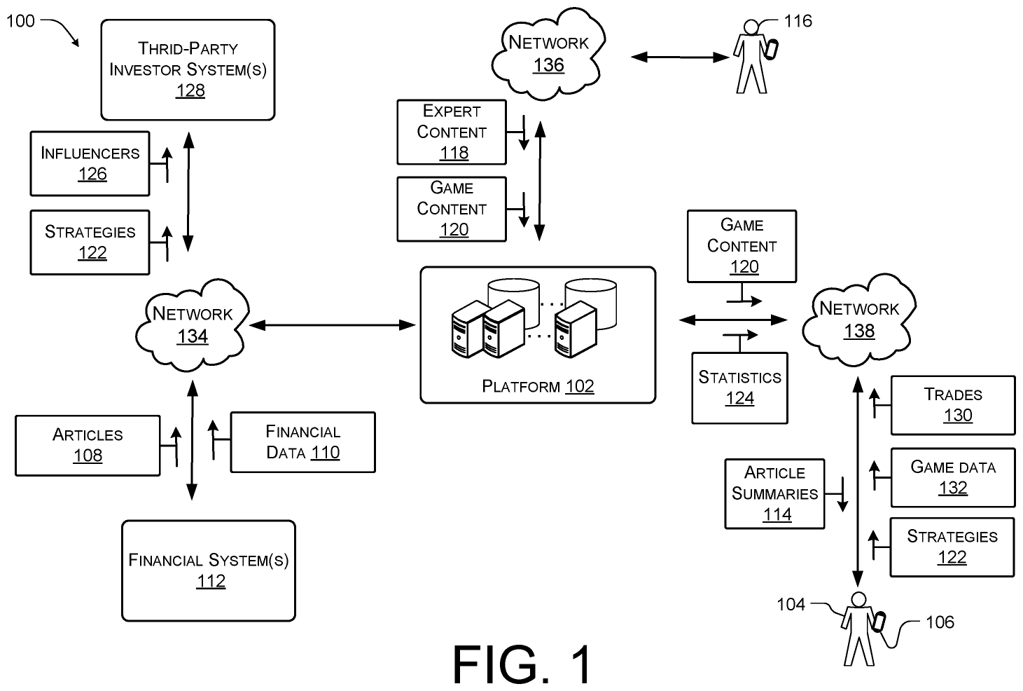

FIG. 1 illustrates an example architecture 100 associated with a trading platform 102 configured to provide educational content according to some implementations. In the illustrated example, the platform 102 may be configured to receive articles 108 and financial data 110 from one or more third-party financial systems 112 (e.g., stock exchanges, other financial sources, etc.). The articles 108 may be related to a specific set of selected companies. In some cases, the companies are selected by the platform 102 or an administrator associated with the platform each day or other time period.

As discussed above, the platform 102 may sort or parse the articles 110 to generate summaries 114. The summaries may include one to two sentences that summarize the key teaching aspects of selected articles 108. For example, the platform 102 may parse or scrape content from the articles 108 and may then validate and rate the articles 108 based on the scraped content. For example, the platform 102 may compare the content of each article to each other to determine authenticity of the articles and factual correctness. The articles 108 that contain overlapping and up-to-date content may then be used to generate the summaries 114 which may be provided to users 104 via an application hosted on the user devices 106, such that the users 104 of the platform 102 may quickly extract the important information and improve the user's knowledge without requiring the user 104 to spend extended time on each article 108. In this way, the platform 102 allows the user 104 to slowly increase knowledge, gathering portions of information and provides an easy way for users 104 to have real world conversations as the platform 102 provides enough information in the summaries to facilitate starter conversations.

In some cases, the platform 102 may employ experts (e.g., professionals and/or influencers) 116, which may generate expert generated content 118 and/or game content 120. For example, as discussed above, the experts 116 may generate expert content 118 and game content 120, such as the show, the knowledge game, and/or the trading game. The show may be for a specified amount of time each period (e.g., day). The show may include a live stream of a topic matter expert providing commentary on the selected companies. In some cases, the expert content 118 of the show may be related to content of the selected and summarized articles 108. During each show, the platform 102 may ask the users 104 a series of market sentiment related questions. The users 104 may not be required to answer the questions, but by answering the questions the users 104 become eligible to participate in a knowledge game content 120.

The knowledge game may include a series of market related questions associated with the selected companies and/or article summaries 114. The questions may be predictive in nature and related to the performance of the stock market (such as with respect to the selected companies) and the platform 102 may then determine a winner based on the performance of the stock market on the following period or day.

The trading game or longer game (e.g., a game having a larger period of time to complete) may include providing the users that qualify with a seed (fictional) monetary value. During the trading game, the users 104 may be able to invest the fictional seed money and compete to see who can earn the highest return during the corresponding period of time. Thus, the winner is determined by the user 104 with the most amount of fictional currency in their virtual trading account at the end of each week. Each user 104 may have the ability to create custom strategies 122 that are comprised of assets, such as stocks, bonds, cryptocurrency, and commodities. The user 104 can have multiple strategies 122. In some cases, the strategies 122 may include the list of assets, allocations, and purchase amounts. In this manner, the user may prepopulate or generate a full trading strategy 122 without placing individual trades as in conventional trading systems. In this manner, the platform 102 discussed herein may reduce the amount of overall network bandwidth, computing resources, user time, and consumed by placing individual trades via a platform 102 when compared with conventional trading systems. For example, the user may select or designated a set of assets associated with one or more companies, a percentage of each asset associated with the strategy 122, and a purchase amount. The platform 102 may then upon receiving an activation of the strategy 122, place the trades to achieve the set of assets at the allocation desired in the correct values based on the purchase amount.

At the end of each period, the winners of the game may be displayed in a leaderboard provided to the users 104 via the statistics 124. However, during the knowledge and trading games, the platform 102 is able to evaluate users 104 and strategies based on a week by week performance. Thus, the platform 102 is able to identify individual users 104 that show a high level of talent or skill with respect to stock trading as well as strategies 122 that emerge as effective in various situations.

For example, if the user 104 has performed above a threshold level (e.g., in the top percentage or earning greater than a threshold amount) throughout a predetermined period of time, the user 104 may be invited by the platform 102 to join as a market influencer 126. As an influencer 126, the user 104 may demonstrate their market performance and share strategies 122. In some cases, either influencers 126 or top performing users may be matched to third-party investors 128 whom want a broker having a strategy or results similar to the performance of the influencer 126 captured during the games. In this manner, the platform 102 is able to identify users 104 that perform well and make either the users (as influencers 126) or the strategies 122 available to investors 128 to select as a more custom or guided investment strategy without requiring hiring a personal broker. In this manner, the platform 102 is able provided guided investment or custom strategy investing to a large portion of the population than conventional trading platforms. Additionally, the investors 128 may view the performance of the users 104 and/or influencers 126 based on the outcome or winnings in the game environment, thus, allowing investors 128 to feel more at ease or to be more easily able to evaluate the skill of the “broker”.

In some cases, the platform 102 may also allow the users 104 to make trades 130 with fiat money as conventional trading platforms would. In some cases, the users 104 may unlock the trading ability by demonstrating sufficient skill via the game content 120 and the user's providing game data 132 (e.g., answers, predictions, and virtual trades).

In various examples, machine learned models or networks may be used to score, rate, or rank articles, game performances, and/or users 104 as discussed above. In some cases, machine learning models and training may include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naive Bayes, Gaussian naive Bayes, multinomial naive Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like.

In the illustrated example, the platform 102 may be communicatively coupled to various other electric devices, systems and user devices 106 and third-party systems 112 and 128 as shown via one or more networks 134-138 via wired technologies (e.g., wires, USB, fiber optic cable, etc.), wireless technologies (e.g., RF, cellular, satellite, Bluetooth, etc.), or other connection technologies. The networks 134-138 may be any type of communication network, including data and/or voice network (such as the internet), and may be implemented using wired infrastructure (e.g., cable, CATS, fiber optic cable, etc.), a wireless infrastructure (e.g., RF, cellular, microwave, satellite, Bluetooth, etc.), and/or other connection technologies. In general, the networks 134-138 carry data, such as the game content 120, between the platform 102, the user devices 106.

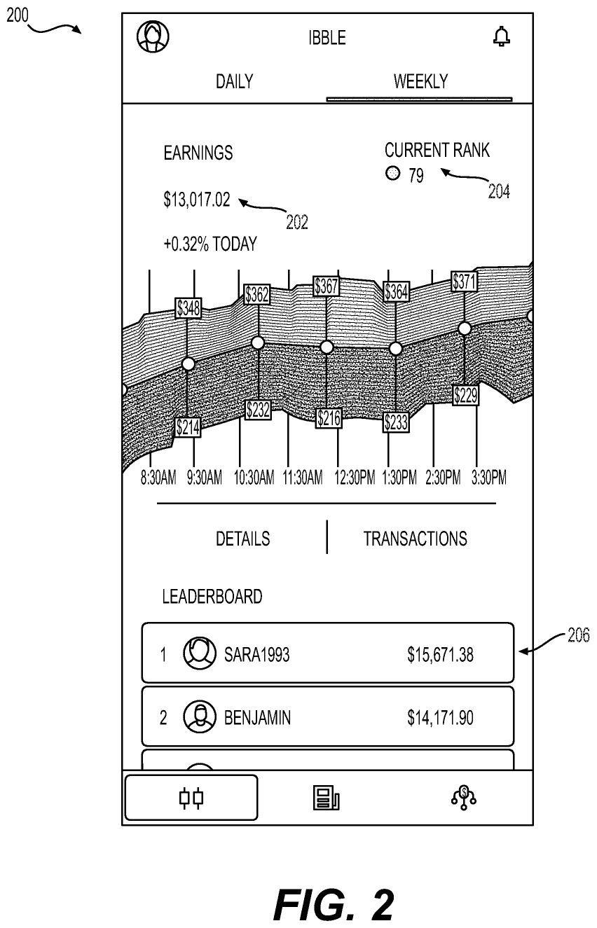

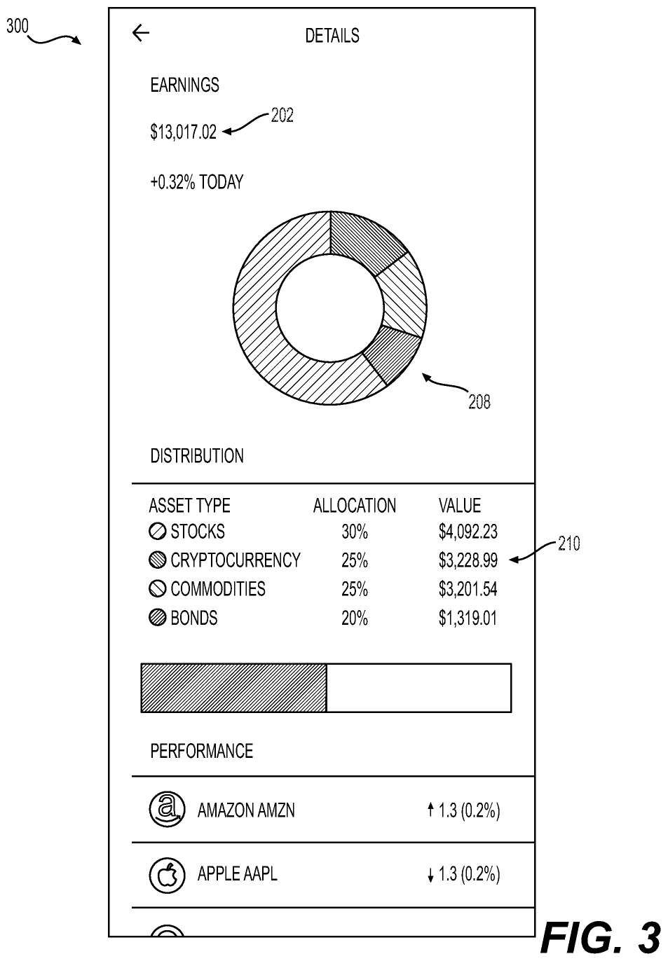

FIGS. 2 and 3 illustrates an example pictorial views 200 and 300 of a user's performance during a trading game associated with the platform of FIG. 1 according to some implementations. For instance, a ranking 204 of the user within the trading game may be based on the user's earnings 202 (e.g., the highest earner wins). The view 200 may also provide a leaderboard 206 or list of the users based on earnings 202, as shown. In some cases, the user interface may include a pictorial representation 208 and/or text-based representation 210 of the user's strategy 208. In the current example, the pictorial representation 208 and/or text-based representation 210 may be similar to those the user would see when trading in fait money and, thus, the user is able to become accustomed to graphs and charts that the user will encounter later when acting as an investor.

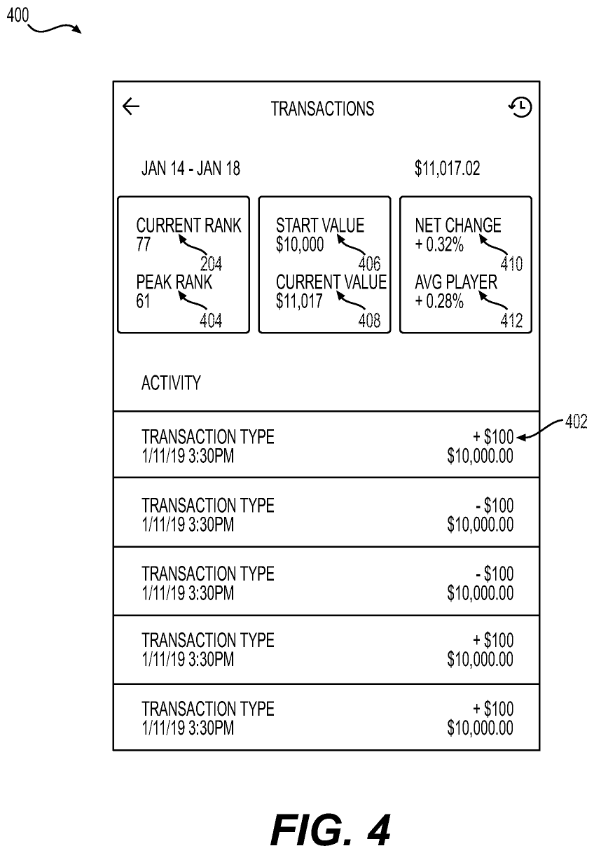

FIG. 4 illustrates an example pictorial view 400 of a user's transaction history 402 associated with the platform of FIG. 1 according to some implementations. In the current view 400, the platform may also provide the user with the rank 204, peak rank 404 as well as a start value 406 (e.g., seed amount) and a current value 408. The view 400 may also present the user with data related to net change 410 as well as a net change associated with an average player 412 of the trading game.

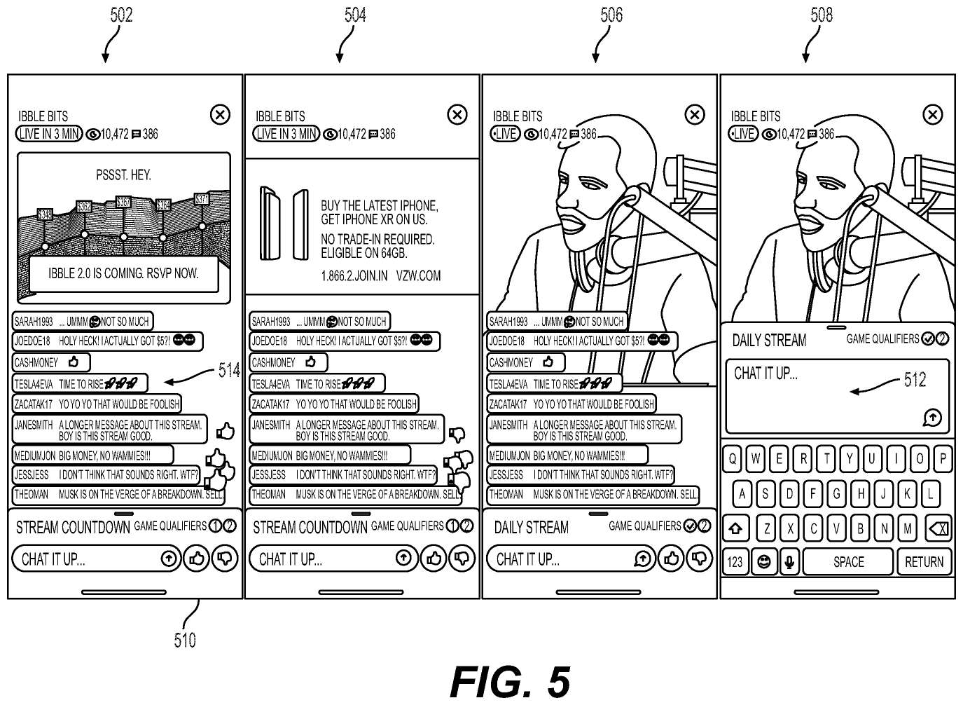

FIG. 5 illustrates an example series of pictorial views 502-508 associated with the show of the platform of FIG. 1 according to some implementations. in the current example, the show may be configured to initiate at a set period of time and may include commentary and video content created by an expert associated with the platform. The content may include images as shown in view 504 as well as allow users to provide feedback via buttons 510 or text insert options 512. The user inputs may then be displayed in a scrolling window 514 for each user viewing the show.

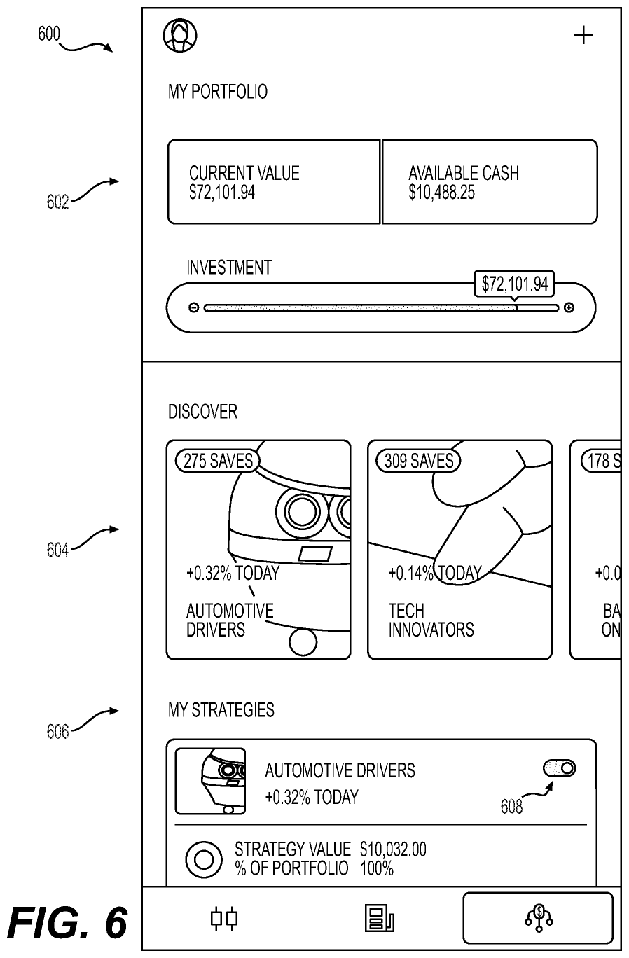

FIG. 6 illustrates an example pictorial view 600 of a user's portfolio associated with the platform of FIG. 1 according to some implementations. In the current example, the user may view the value of the portfolio 602 (e.g., in real money), review educational material 604, such as the summaries, and review the user's strategies 606. In this example, the user may turn on and off the strategies 606 by clicking the on off selector 608. In this manner, the user may easily buy and sell stocks without having to place individual transactions as in conventional stock trading platforms.

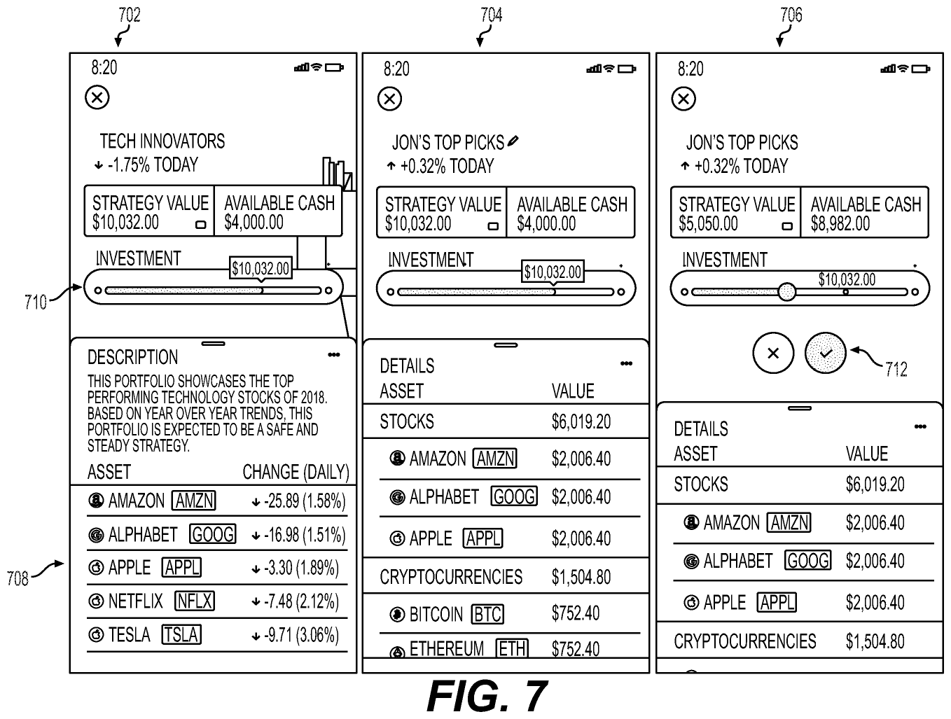

FIG. 7 illustrates an example series of pictorial views 702-706 associated with trading based on strategies associated with the platform of FIG. 1 according to some implementations. As discussed above, the user may predefine a plurality of strategies that may include specific assets and amounts to purchase. During the trading game, the user may activate the strategies in various ways, such as selecting the on off selector 608. In the current example, the user may be viewing a single strategy that includes the assets 708 listed. In this example, the user may adjust the monetary amount that the user wants to associate with the selected strategy by sliding the control 710 and in some cases, selecting the approve button 712 (e.g., when adjusting the control 710 results in actual trades being made).

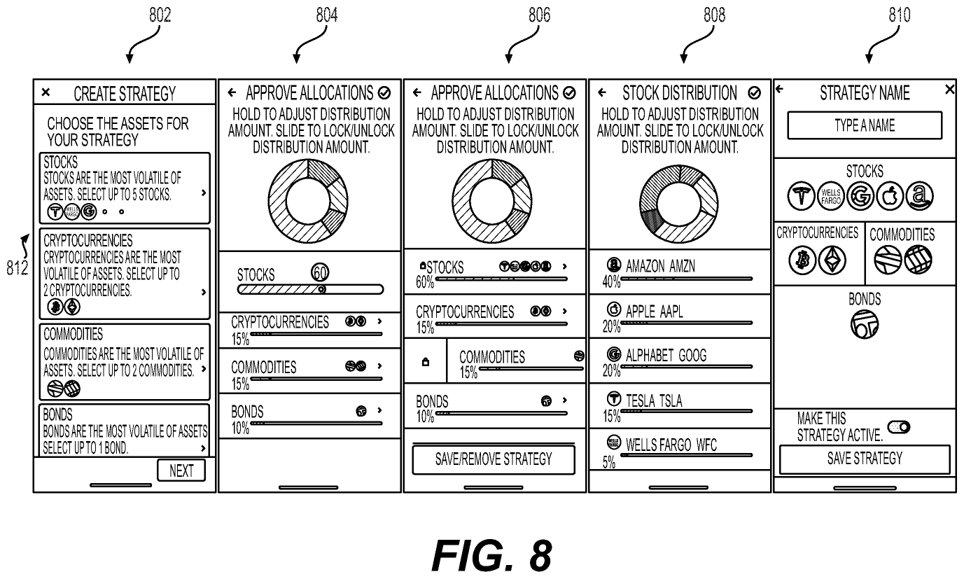

FIG. 8 illustrates an example series of pictorial views 802-808 associated with creating strategies associated with the platform of FIG. 1 according to some implementations. For example, the user may create strategies offline or during times when a game is not active. In this case, the users may generate a strategy by selecting a type of asset 812 (e.g., stocks, bonds, cryptocurrencies, commodities, etc.). Next the user may select and approve allocations between assets 812 as shown in views 804 and 808. The user may update or modify the allocation, as shown in view 808, and/or apply a name or title to the strategy for easy reference, as shown in view 810.

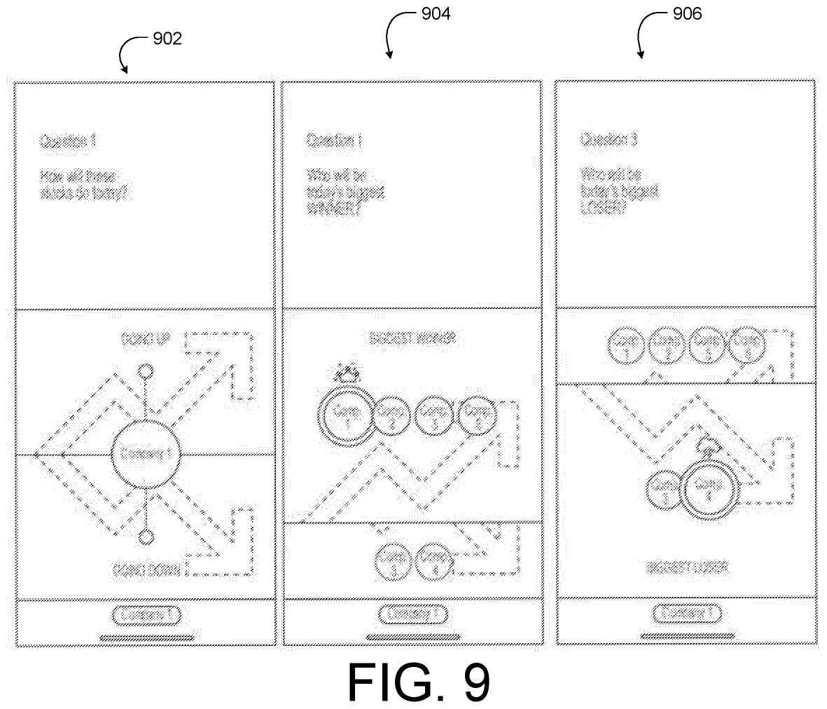

FIG. 9 illustrates an example series of pictorial views 902-906 associated with a knowledge game (e.g., the daily game) associated with the platform of FIG. 1 according to some implementations. In the current examples, the user may be asked a series of questions, such as questions 1-3 (on the PDF Question 2 is actually labeled Question 1), related to the set of companies selected by the platform for the current period (e.g., day). In some cases, the questions may include a yes-no or up-down type questions, as shown in view 902. In other cases, the questions may include selecting between the companies, such as shown in views 904 and 906.

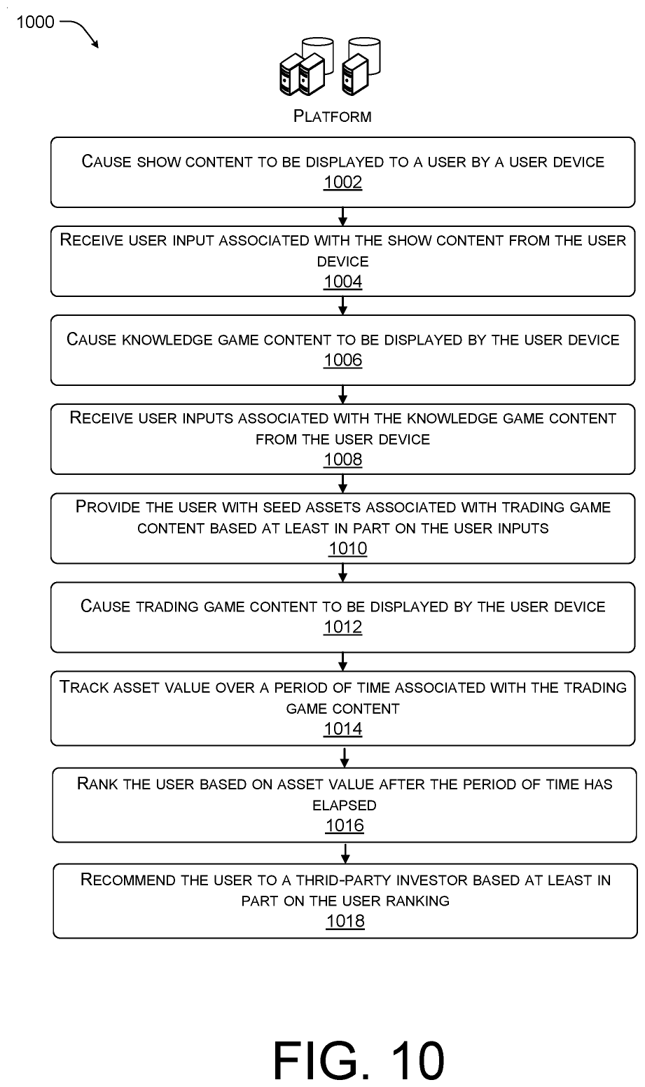

FIGS. 10-12 are flow diagrams illustrating example processes associated with the platform 102 of FIG. 1 and the application views of FIGS. 2-8 according to some implementations. The processes are illustrated as a collection of blocks in a logical flow diagram, which represent a sequence of operations, some or all of which can be implemented in hardware, software, or a combination thereof In the context of software, the blocks represent computer-executable instructions stored on one or more computer-readable media that, which when executed by one or more processors, perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the process, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 10 illustrates an example flow diagram showing an illustrative process 1000 for identifying influencers according to some implementations. As discussed above, the platform may act to educate users based on summaries of articles and shows and then to test or track progress of the users based on various games, such as a knowledge game (e.g., daily game) and a trading game (e.g., a weekly game). The platform may then identify skilled or talented individuals as influencers and then recommend the influencer or the influencer's strategies to third-party investors.

At 1002, the platform may cause show (e.g., the show) content to be displayed to a user by a user device. For example, the platform may push or stream the show content to user devices in communication with the platform at a specified period of time. In this manner, the show content may be available for a period of time and provided at regular or periodic interfaces (such as daily).

At 1004, the platform may receive user input associated with the show content from the user device. For example, the platform may receive feedback such as likes and dislikes, commentary, and the such from the user devices. In some specific examples, the platform may receive feedback to one or more questions associated with the show. In some cases, by providing user input during the show or the period of time associated with the show, the platform may qualify the user for the knowledge game.

At 1006, the platform may cause knowledge game content to be displayed by the user device. For example, the platform may provide a series of questions to the user device. In some cases, the user may have a specific period or window of time to respond to the questions. The questions may be multiple choice and/or binary. In some cases, the questions may be a prediction of a future event (such as top market performing company during the next day or market period). In some cases, the questions may be limited to a set of companies selected by the platform for increasing the user's knowledge in a specific area of trading. In some examples, the number of questions sent to the user device may depend on an overall number of players or users that participate in the knowledge game during the corresponding period of time (e.g., the greater the number of users, the greater the number of questions).

At 1008, the platform may receive user inputs associated with the knowledge game content from the user device. For example, the user inputs may include the user's answers or predictions with respect to the presented questions. In some cases, the platform may determine a winner of the knowledge game based on the user inputs and a future outcome, such as the actual performance of various stocks of the set of companies during the following market period or day.

At 1010, the platform may provide the user with seed assets associated with the trading game content. For example, an amount of seed assets for the trading game may be based on the user's performance with respect to the knowledge game (e.g., the high the rank in the knowledge game, the more seed assets in the trading game). In other cases, the seed assets may be equal for all users participating in the trading game.

At 1012, the platform may cause trading game content to be displayed by the user device, and, at 1014, the platform may track asset value over a period of time associated with the trading game content. For example, the trading game content may allow the user to trade assets and employ strategies. The platform may simulate a virtual stock exchange utilizing data from financial system and the trades made by the users based on the seed assets.

At 1016, the platform may rank the users based on the asset value after the period of time ahs elapsed. For example, the user that has the highest asset value after the period of time has elapsed may be considered the highest ranked user.

At 1018, the platform may recommend the user to a third-party investor based at least in part on the user ranking. For instance, if the user (and/or one of the user's strategies) consistently ranks above a threshold value (e.g., asset value) or user threshold (e.g., top user), the platform may identify the user as an influencer and allow the influencer to act as a broker for third-party investors and/or provide the user's strategies to the third-party investors.

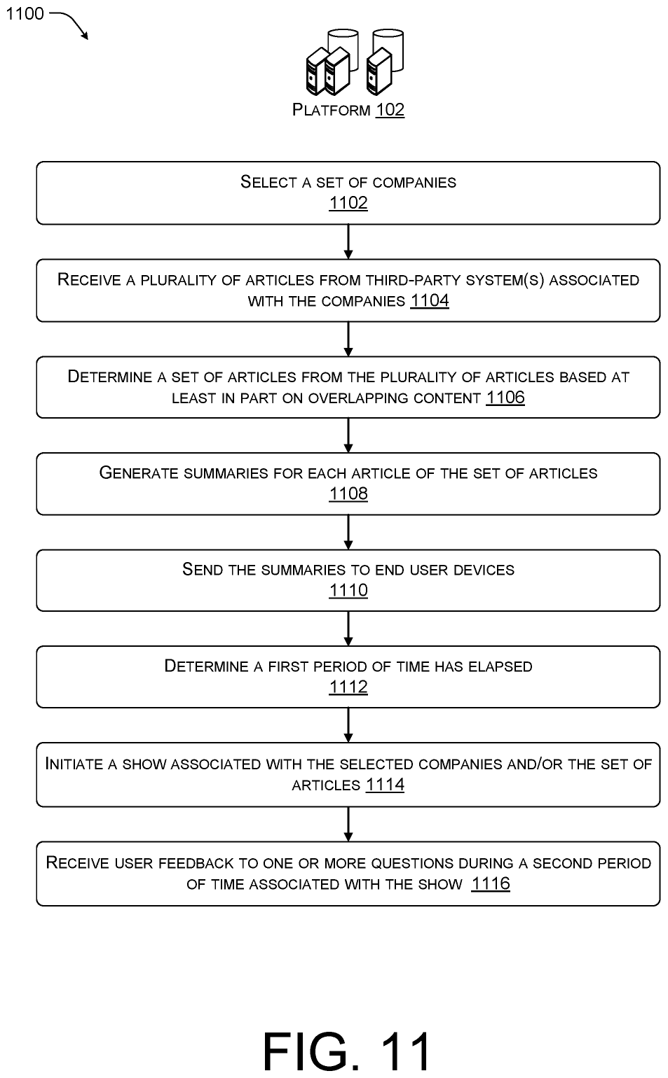

FIG. 11 illustrates an example flow diagram showing an illustrative process 1100 providing educational content to a user according to some implementations. As discussed above, the platform, discussed herein, may be configured to educate the users via article summaries, shows, and games, such that the user becomes accustomed to trading in an incremental manner.

At 1102, the platform may select a set of companies. The set of companies may be a predetermined number of companies (such as 4, 5, or 6) and, in some cases, may be related to a particular field, type of asset, technology, etc.

At 1104, the platform may receive a plurality of articles from third-party systems associated with the companies. The articles may be obtained from various publications, financial institutes, and/or fact-based sources. In some cases, the platform may identify or otherwise locate the articles while, in other cases, the third-party systems may provide the articles.

At 1106, the platform may determine a set of articles from the plurality of articles base at least in part on overlapping content. For example, the platform or a review system/individual associated with the platform may parse the content of the articles to identify common or overlapping content. When the content is overlapping or common, the content is more likely to be important or news worthy and, thereby, more likely to be valuable educational content.

At 1108, the platform may generate summaries for each article of the set of articles, and, at 1110, the platform may send the summaries to the end user devices. For instance, the platform may extract fact based content or other important topically content from each article to generate a summary that can be quickly consumed by the users of the platform. In this manner, the users may quickly scroll or skim through the summaries to gain a basic understanding of the events happing during the day and effecting the asset value.

At 1112, the platform may determine a first period of time has elapsed and, at 1114, the platform may initiate a show associated with the selected companies and/or the set of articles. For instance, the first period may be a period of time from the last show and upon the period of time elapsing, the platform may determine that it is time for another show. Each show may be related to the companies and/or articles provided during the period of time, such that the users may educate themselves on the companies and/or articles prior to consuming the show content.

At 1116, the platform may receive user feedback to one or more questions during a second period of time associated with the show. In some cases, the one or more questions may be related to the set of companies and/or the set of articles. The questions may be part of the show and/or part of the knowledge game content. In some instances, the knowledge game may take place during the second period of time associated with the show.

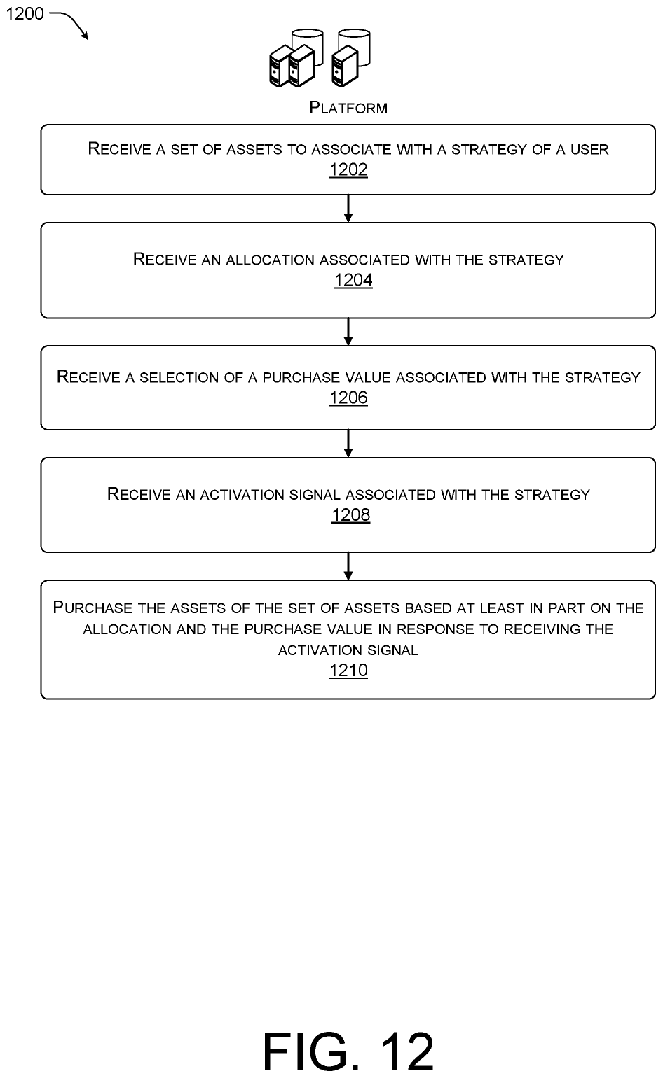

FIG. 12 illustrates an example flow diagram showing an illustrative process 1200 associated with the trading game content according to some implementations. as discussed above, the platform may utilize the trading game content to rank the users and/or identify influencers and strategies that may be used to assist third-party investors with investing their assets. In some cases, the trading game content may be configured to allow the users to invest with predefined strategies rather than making individual or per asset trades. In this way, the users may participate in the trading game without requiring committing a substantial amount of time. In some cases, the users may reuse strategies that performed well or make modifications to strategies without starting over from scratch.

At 1202, the platform may receive a set of assets to associate with a strategy of a user. For example, the user may select a set of assets (stocks, bonds, cryptocurrency, mutual funds, etc.) that the user desires to associate with the strategy. In some cases, the strategy may be associated with as few as a single asset.

At 1204, the platform may receive an allocation associated with the strategy. For example, the user may select percentages or amounts to assign to the different assets of the set of assets. Thus, it should be understood, that the allocation is a distribution or relationship of the assets within the set of assets.

At 1206, the platform may receive a selection of a purchase value associated with the strategy and, at 1208, the platform may receive an activation signal associated with the strategy. The purchase value may be invested by the platform based on the allocation selected by the user upon receiving the activation signal. In some cases, the activation signal may be received following the asset selection, the allocation, and purchase value, while, in other cases, the activation signal may be received at a time associated with a subsequent trading game. In this manner, each time a trading game begins the user may utilize one or more of the preprogrammed strategies to purchase the assets. At 1210, the platform may purchase the set of assets based at least in part on the allocation and the purchase value in response to receiving the activation signal, as discussed above.

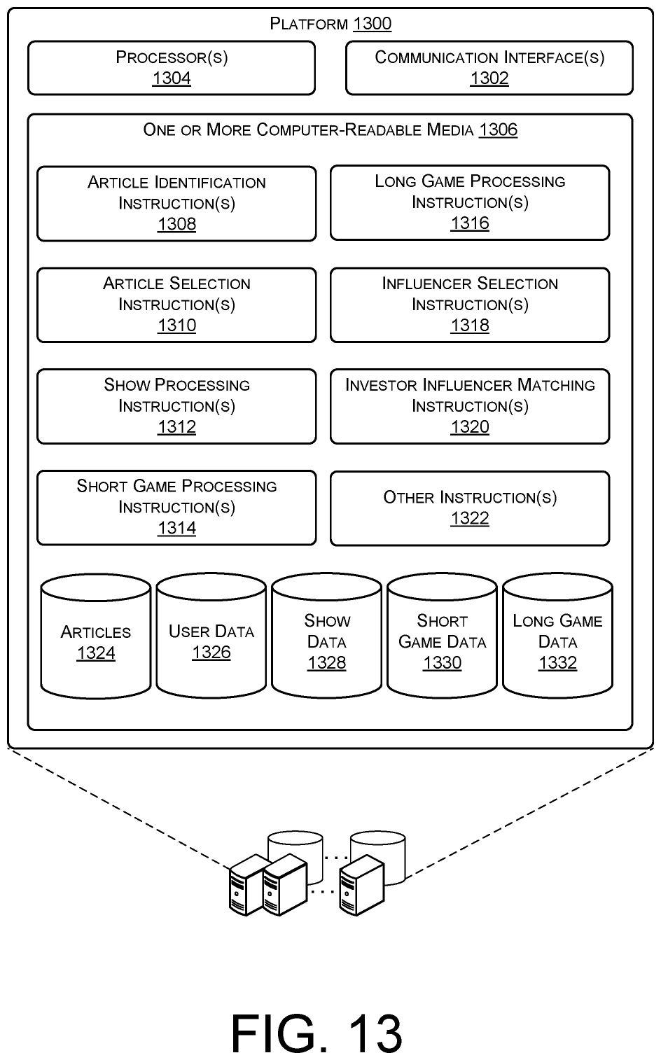

FIG. 13 illustrates an example platform 1300 associated with providing education-based asset trading according to some implementations. In the illustrated example, the platform 1300 may be the platform 102 of FIG. 1 and may include one or more communication interfaces 1302 configured to facilitate communication between one or more networks, one or more system (e.g., user devices, third-party systems, validation systems, etc.). The communication interfaces 1302 may also facilitate communication between one or more wireless access points, a master device, and/or one or more other computing devices as part of an ad-hoc or home network system. The communication interfaces 1302 may support both wired and wireless connection to various networks, such as cellular networks, radio, WiFi networks, short-range or near-field networks (e.g., Bluetooth®), infrared signals, local area networks, wide area networks, the Internet, and so forth.

The platform 1300 includes one or more processors 1304, such as at least one or more access components, control logic circuits, central processing units, or processors, as well as one or more computer-readable media 1306 to perform the function of the platform 1300. Additionally, each of the processors 1304 may itself comprise one or more processors or processing cores.

Depending on the configuration, the computer-readable media 1306 may be an example of tangible non-transitory computer storage media and may include volatile and nonvolatile memory and/or removable and non-removable media implemented in any type of technology for storage of information such as computer-readable instructions or modules, data structures, program modules or other data. Such computer-readable media may include, but is not limited to, RAM, ROM, EEPROM, flash memory or other computer-readable media technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, or any other medium that can be used to store information and which can be accessed by the processors 804.

Several modules such as instructions, data stores, and so forth may be stored within the computer-readable media 1306 and configured to execute on the processors 1304. For example, as illustrated, the computer-readable media 1306 stores article identification instructions 1308, article selection instructions 1310, show processing instructions 1312, knowledge game processing instructions 1314, trading game processing instructions 1316, influencer selection instructions 1318, investor influencer matching instructions 1320, as well as other instructions 1322, such as an operating system.

The computer-readable media 1306 may also be configured to store data, such as articles 1324, user data 1326, show data 1328, knowledge game data 1330, trading game data 1332, among other types of data. The articles 1324 may include third-party articles. The user data 1326 may include preferences, strategies, rankings, etc. The show data 1328 may be content provided as part of the show as well as any associated questions, comments, or other user feedback. The knowledge game data 1330 may include data associated with the knowledge game such as questions, answers, predictions, outcomes, etc. The trading game data 1332 may include the trading simulation data as well as the purchases, trades, etc. made by the individual users during a current game.

The article identification instructions 1308 may be configured to identify articles that are related to a technology, strategy, event, or other item that may be the focus of the show and/or the knowledge game. In some case, the article may be related to a set of selected companies. The article selection instructions 1310 may be configured to select articles from the identified articles to summarize and provide as educational content. Again, the selected articles may relate to a set of companies associated with the show and/or the knowledge game.

The show processing instructions 1312 may be configured to alert users that a show is about to start. The show processing instructions 1312 may also be configured to stream the content of the show to the user devices and to receive comments and other feedback from the user via the user devices. The show processing instructions 1312 may also qualify users for participation in the knowledge game.

The knowledge game processing instructions 1314 may be configured to present questions related to the set of companies and/or the set of articles and to collect user feedback. In some cases, the knowledge game processing instructions 1314 may track user progress, skill level, etc.

The trading game processing instructions 1316 may be configured to cause a trading simulation that allows the user to make trades using virtual seed value and to track the return on investment over a period of time. The trading game processing instructions 1316 may be configured to allow the user to trade via stored strategies, as discussed above.

The influencer selection instructions 1318 may be configured to identify individual users as top performers or skilled traders based at least in part on the users and/or the user's strategies performance during the knowledge and trading games.

The investor influencer matching instructions 1320 may be configured to match influencers and third-party investors based on user performance, user strategies, interest areas, etc.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A system comprising:
one or more communication interfaces;
one or more processors; and
computer-readable storage media storing computer-executable instructions, which when executed by the one or more processors cause the one or more processors to perform operations comprising:
sending to a user device a plurality of article summaries, the plurality of article summaries having related content;
sending to a user device video content, the video content associated with the related content of the plurality of article summaries;
sending to the user device the set of knowledge-based questions associated the related content of the plurality of article summaries;
receiving, from the user device answers to the set of knowledge-based questions;
qualifying a user associated with the user device to participate in a trading simulation in response to receiving the answers;
receiving, from the user device, an activation signal, the activation signal associated with a predetermined strategy;
purchasing assets within the trading simulation based at least in part on the predetermined strategy on behalf of the user;
determining an earnings value associated with the user and the trading simulation in response to the period of time elapsing;
identifying the user as an influencer based at least in part on the earnings value; and
matching the user with a third-party investor in response to identifying the user as an influencer.

2. The system as recited in claim 1, wherein the predetermined strategy includes an asset allocation and a purchase value.

3. The system as recited in claim 1, wherein the operations further comprise determining a ranking associated with the user and the trading simulation based at least in part on the earnings value and prior earnings values associated with prior trading simulations.

4. The system as recited in claim 3, wherein matching the user with a third-party investor is based at least in part on the ranking

5. The system as recited in claim 3, wherein identifying the user as the influencer is based at least in part on the prior earnings values.

6. The system as recited in claim 1, wherein the operations further comprise determining that a period of time associated with the trading simulation has elapsed prior to determining the earrings value.

7. The system as recited in claim 1, wherein the operations further comprise:
determine content of articles used to generate the plurality of article summaries are related to a set of specified companies prior to generating the plurality of article summaries.

8. The system as recited in claim 1, wherein the operations further comprise:
determining that the video content was consumed via the user device; and
qualifying the user to receive the set of knowledge-based questions in response to determining that the video content was consumed.

9. A method comprising:
sending to a user device a plurality of article summaries associated with a set of companies;
sending to a user device video content, the video content associated with the set of companies;
determining that a user of the user device consumed the video content;
qualifying the user to receive a set of knowledge-based questions in response to determining that the user consumed the video content, the set of knowledge-based questions related to the plurality of article summaries;
sending to the user device the set of knowledge-based questions;
receiving, from the user device, a response, the response associated with answers to the set of knowledge-based questions;
qualifying a user associated with the user device to participate in a trading simulation in response to receiving the response;
receiving, from the user device, an activation signal, the activation signal associated with a predetermined strategy;
purchasing assets based at least in part on the predetermined strategy on behalf of the user within the trading simulation;
determining that a period of time associated with the trading simulation has elapsed;
determining an earnings value associated with the user and the trading simulation in response to the period of time elapsing;
identifying the user as an influencer based at least in part on the earnings value being greater than a threshold value; and
matching the user with a third-party investor in response to identifying the user as an influencer.

10. The method as recited in claim 9, further comprising:
receiving a plurality of articles from a third-party source, the plurality of articles associated with current financial events; and
determining, based at least in part on content of the plurality of articles, a subset of the plurality of articles, the subset of articles associated with the plurality of article summaries.

11. The method as recited in claim 10, further comprising:
determining, based at least in part on the content of the plurality of articles, the set of companies; and
wherein determining the subset of the plurality of articles is based at least in part on individual articles of the subset of the plurality of articles having overlapping content related to at least one of the set of companies.

12. The method as recited in claim 9, wherein qualifying the user to participate in a trading simulation includes determining a seed value associated with the user, the seed value being a starting monitory value associated with the simulation.

13. The method as recited in claim 9, wherein purchasing assets based at least in part on the predetermined strategy on behalf of the user within the trading simulation further comprises purchasing the assets specified in the predetermined strategy based on an allocation and a purchase value.

14. The method as recited in claim 9, wherein identifying the user as the influencer is based at least in part on a second earnings value associated with a second trading simulation being greater than the threshold value.

15. The method as recited in claim 9, wherein matching the user with the third-party investor is based at least in part on data associated with the third-party investor and the predetermined strategy.

16. A method comprising:
qualifying a user associated with a user device to participate in an instance of a trading simulation based at least in part on user interaction with a platform;
receiving, from the user device, an activation signal, the activation signal associated with a predetermined strategy, the predetermined strategy includes at least one asset, an allocation metric, and a purchase value;
virtually purchasing assets within the trading simulation based at least in part on the predetermined strategy;
determining a user ranking associated with the trading simulation, the ranking based on earning value of the user associated with the instance of the trading simulation and prior instances of the trading simulation in which the user participated;
identifying the user as an influencer based at least in part on the user ranking; and
matching the user with a third-party investor in response to identifying the user as an influencer.

17. The method as recited in claim 16, further comprising:
receiving a plurality of articles from a third-party source, the plurality of articles associated with current financial events;
determining, based at least in part on content of the plurality of articles, a subset of the plurality of articles;
generating a plurality of article summaries associated with the subset of articles associated;
sending the plurality of article summaries to the user device;
sending to the user device the set of knowledge-based questions, the set of knowledge-based questions associated with the plurality of article summaries; and
wherein qualifying the user associated with the user device to participate in the instance of the trading simulation is based at least in part on receiving a response to the set of knowledge-based questions.

18. The method as recited in claim 17, wherein the plurality of article summaries are associated with content related to a set of companies.

19. The method as recited in claim 16, wherein each instance of the trading simulation is associated with a predetermined period of time.

20. The method as recited in claim 16, wherein matching the user with the third-party investor is based at least in part on the assets and allocation associated with the predetermined strategy.
